(19) United States
(12) Patent Application Publication
(10) Pub. No.: US 2022/0394149 A1
(43) Pub. Date: Dec. 8, 2022

(54) FILE MANAGEMENT SYSTEM, INFORMATION PROCESSING APPARATUS, IMAGE CAPTURING APPARATUS, AND FILE MANAGEMENT METHOD

(71) Applicant: Sony Group Corporation, Tokyo (JP)

(72) Inventor: Kazuma Akamatsu, Tokyo (JP)

(21) Appl. No.: 17/776,051

(22) PCT Filed: Dec. 2, 2020
(86) PCT No.: PCT/JP2020/044797

§ 371 Date: May 11, 2022

(30) Foreign Application Priority Data
Dec. 16, 2019 (JP) 2019-226187

(51) Int. Cl. H04N 1/32; G06F 16/18; H04N 1/00

(52) U.S. Cl. CPC H04N 1/32101; G06F 16/1873; H04N 1/00172

(57) ABSTRACT

The present technology relates to a file management system, an information processing apparatus, an image capturing apparatus, and a file management method that enable a start of an image capturing operation before issuance of a formal file name.

The image capturing apparatus saves an image file including a captured image, with a temporary file name irrespective of whether or not the image capturing apparatus is connected to the information processing apparatus, and transmits the temporary file name to the information processing apparatus at an image capturing timing. The information processing apparatus fires a formal file name for the image file when the temporary file name is received. The present technology is applicable to, for example, a file management system that saves image files with sequential file names in a plurality of image capturing apparatuses.

### TECHNICAL FIELD

The present technology relates to a file management system, an information processing apparatus, an image capturing apparatus, and a file management method. The present technology particularly relates to a file management system, an information processing apparatus, an image capturing apparatus, and a file management method that enable a start of an image capturing operation before issuance of a formal file name.

### BACKGROUND ART

When an image is captured by an image capturing apparatus such as a digital camera, the image is saved as an image file. For example, in a case where images are captured by a plurality of image capturing apparatuses and image files saved by the respective image capturing apparatuses are imported to one PC or the like, the image files cannot be saved in an order of image capturing operations by the plurality of image capturing apparatuses.

For example, Patent Document 1 proposes such a technology that a file number distribution apparatus issues a file number and an image capturing apparatus saves an image with the file number issued by the file number distribution apparatus.

### CITATION LIST

### Patent Document

Patent Document 1: Japanese Patent Application Laid-Open No. 2016-5106

### SUMMARY OF THE INVENTION

### Problems to be Solved by the Invention

According to the technology described in Patent Document 1, in a state in which a connection between the image capturing apparatus and the file number distribution apparatus is established, the image capturing apparatus has been incapable of performing the next image capturing operation until the file number distribution apparatus issues a file number.

The present technology has been made in view of such a circumstance and enables a start of a next image capturing operation before issuance of a formal file name.

### Solutions to Problems

A first aspect of the present technology is directed to a file management system including: an image capturing apparatus; and an information processing apparatus connectable to the image capturing apparatus, in which the image capturing apparatus includes: a temporary file name save unit configured to save an image file including a captured image, with a temporary file name irrespective of whether or not the image capturing apparatus is connected to the information processing apparatus; and a temporal file name transmission unit configured to transmit the temporary file name to the information processing apparatus at an image capturing timing, and the information processing apparatus includes a formal file name fixing unit configured to fix a formal file name for the image file when the temporary file name is received.

A second aspect of the present technology is directed to an information processing apparatus including: a temporary file name reception unit configured to receive a temporary file name transmitted from an image capturing apparatus; and a formal file name fixing unit configured to fix a formal file name for an image file saved in the image capturing apparatus with the temporary file name, when the temporary file name is received.

A third aspect of the present technology is directed to an image capturing apparatus including: a temporary file name save unit configured to save an image file including a captured image, with a temporary file name irrespective of whether or not the image capturing apparatus is connected to an information processing apparatus; and a temporary file name transmission unit configured to transmit the temporary file name to the information processing apparatus that fixes a formal file name for the image file, at an image capturing timing.

According to the first aspect of the present technology, an image file including a captured image is saved with a temporary file name irrespective of whether or not the image capturing apparatus is connected to the information processing apparatus, the temporary file name is transmitted to the information processing apparatus at an image capturing timing, and a formal file name is fixed for the image file when the temporary file name is received.

According to the second aspect of the present technology, a temporary file name transmitted from the image capturing apparatus is received, and a formal file name is fixed for an image file saved in the image capturing apparatus with the temporary file name, when the temporary file name is received.

According to the third aspect of the present technology, an image file including a captured image is saved with a temporary file name irrespective of whether or not the image capturing apparatus is connected to the information processing apparatus, and the temporary file name is transmitted to the information processing apparatus that fixes a formal file name for the image file, at an image capturing timing.

### BRIEF DESCRIPTION OF DRAWINGS

FIG. 1 is a diagram illustrating a configuration example of a file management system according to an embodiment of the present technology.

FIG. 2 is a diagram illustrating a flow of processing by the file management system.

FIG. 3 is a block diagram illustrating a hardware configuration example of an image capturing apparatus.

FIG. 4 is a block diagram illustrating a functional configuration example of a slave camera.

FIG. 5 is a block diagram illustrating a functional configuration example of a master camera.

FIG. 6 is a flowchart depicting processing by the file management system.

FIG. 7 is a flowchart depicting another processing by the file management system.

FIG. 8 is a block diagram illustrating a functional configuration example of the slave camera.

FIG. 9 is a block diagram illustrating a functional configuration example of the master camera.

FIG. 10 is a flowchart depicting processing by the file management system.

FIG. 11 is a flowchart depicting another processing by the file management system.

FIG. 12 is a flowchart depicting processing by the file management system.

FIG. 13 is a block diagram illustrating a functional configuration example of the slave camera.

FIG. 14 is a flowchart depicting processing by the file management system.

FIG. 15 is a diagram illustrating an example of a screen displayed on a display unit.

FIG. 16 is a block diagram illustrating a hardware configuration example of a computer.

### MODE FOR CARRYING OUT THE INVENTION

Hereinafter, a description will be given of modes for carrying out the present technology. The description is given in the following order.

1. Overview of file management system

2. Configuration of each appliance

3. Operation of each appliance

4. Case where image file is saved in master camera

5. Case where image is captured in state in which connection is not established

6. Modifications

7. Configuration example of computer

### <1. Overview of File Management System>

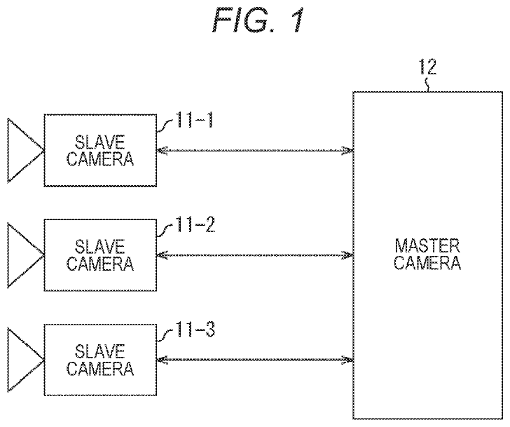

FIG. 1 is a diagram illustrating a configuration example of a file management system according to an embodiment of the present technology.

The file management system in FIG. 1 is constituted of slave cameras 11-1 to 11-3 and a master camera 12.

Each of the slave camera 11-1, the slave camera 11-2, the slave camera 11-3, and the master camera 12 is an image capturing apparatus that captures an image.

In a case where each of the slave cameras 11-1 to 11-3 captures an image, each of the slave cameras 11-1 to 11-3 makes a request to issue a file name to the master camera 12, and saves an image file in a medium with the file name issued by the master camera 12. The request to issue a file name is made, for example, every image capturing operation. Note that although FIG. 1 illustrates three slave cameras, the number of slave cameras may be any number.

Hereinafter, the slave cameras 11-1 to 11-3 will collectively be referred to as a slave camera 11 as appropriate in a case where there is no necessity to distinguish the slave cameras 11-1 to 11-3 from one another.

The master camera 12 also functions as an information processing apparatus that issues a file name.

The slave camera 11 and the master camera 12 are each constituted of a device such as a camera, a smartphone, a tablet terminal, or a PC. Different devices may be mixed in the file management system such that the slave camera 11 is constituted of a camera and the master camera 12 is constituted of a smartphone.

In a use case where image capturing performance is required at a high level, such as sports reporting, only a camera may be used as a device constituting each of the slave camera 11 and the master camera 12. Furthermore, in a use case where there is no emphasis on an image capturing operation by the master camera 12, a camera may be used as a device constituting the slave camera 11 and a smartphone may be used as a device constituting the master camera 12.

Each of the slave cameras 11-1 to 11-3 is connected to the master camera 12 via wireless communication such as a wireless local area network (LAN) or Bluetooth (registered trademark). Each of the slave cameras 11-1 to 11-3 may be connected to the master camera 12 via a predetermined network such as the Internet or a LAN.

In the file management system having such a configuration, the master camera 12 discriminates the slave cameras 11-1 to 11-3 by, for example, the following method.

The slave camera 11 transmits an appliance discovery signal in accordance with a predetermined protocol such as a simple service discovery protocol (SSDP). The master camera 12 receives the signal transmitted from the slave camera 11 and establishes a connection with the slave camera 11.

The master camera 12 assigns a session ID to each of the slave cameras 11-1 to 11-3 with which the connection has been established, thereby making the slave cameras 11-1 to 11-3 discriminatable. For example, the master camera 12 assigns IDs: 1 to 3 to the slave cameras 11-1 to 11-3, respectively.

Transmission and reception of a command requesting issuance of a file name by the slave camera 11 and a file name issued by the master camera 12 are executed on an established session. The master camera 12 is capable of discriminating the slave camera 11 that has transmitted the command requesting issuance of the file name, on the basis of the session ID.

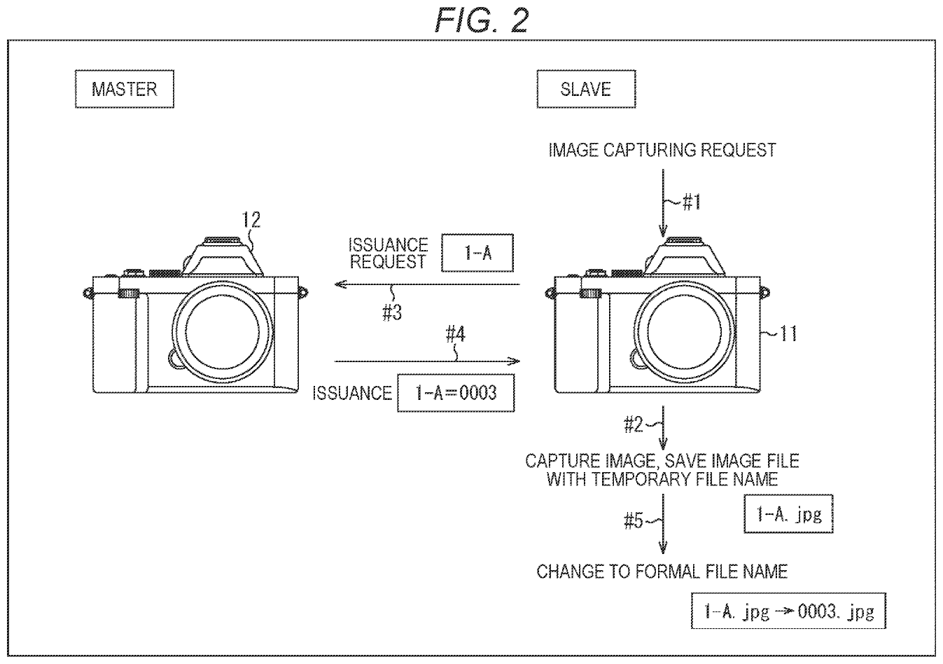

FIG. 2 is a diagram illustrating a flow of processing by the file management system.

FIG. 2 illustrates one image capturing apparatus as the slave camera 11.

When the slave camera 11 receives an image capturing request from a user as indicated by an arrow #1, then the slave camera 11 captures an image and saves an image file with a temporary file name as indicated by a point of an arrow #2. For example, the user makes an image capturing request to the slave camera 11 by pressing a shutter button of the slave camera 11. Here, an image file is saved with a temporary file name irrespective of whether or not the slave camera 11 is connected to the master camera 12.

The temporary file name is a file name excluding an extension, for saving an image file in the slave camera 11. In the example of FIG. 2, an image file is saved in the slave camera 11 with a temporary file name “1-A”. An extension “.jpg” is added to the temporary file name.

As indicated by an arrow #3, the slave camera 11 transmits, to the master camera 12, a formal file name issuance request command that is a command for requesting issuance of a formal file name. In the example of FIG. 2, the slave camera 11 transmits, to the master camera 12, a formal file name issuance request command including the temporary file name “1-A”. Here, the transmission of the formal file name issuance request command corresponds to transmission of the temporary file name.

Note that the slave camera 11 may separately transmit the temporary file name and the formal file name issuance request command linked with the temporary file name.

As indicated by an arrow #4, when the master camera 12 receives the temporary file name, then the master camera 12 issues a formal file name for the image file saved with the temporary file name.

The formal file name is a file name excluding an extension, and the master camera 12 fixes the formal file name for the image file on the basis of a receiving order of the temporary file name.

The master camera 12 manages a latest number for issuing such a formal file name. The master camera 12 issues the formal file name including the latest number, and transmits the formal file name to the slave camera 11 with the formal file name associated with the temporary file name. In the example of FIG. 2, the latest number “0003” is transmitted as the formal file name. The formal file name “0003” is associated with the temporary file name “1-A”.

After transmitting the formal file name, the master camera 12 updates the latest number. In the example of FIG. 2, the latest number to be assigned to the next image file is “0004”.

As indicated by a point of an arrow #5, when the slave camera 11 receives the formal file name, then the slave camera 11 changes the file name of the image file saved with the temporary file name, using the formal file name. In the example of FIG. 2, the file name of the image file is changed from “1-A.jpg” to “0003.jpg” including the number as the formal file name. Note that each of the temporary file name and the formal file name may include an extension. In this case, in the example of FIG. 2, “1-A.jpg” is the temporary file name. Furthermore, in renaming the image file to the formal file name, “0003.jpg” is the formal file name.

Note that, in a case where a plurality of image capturing apparatuses is used as the slave cameras 11, the master camera 12 issues a formal file name to an image file saved in each image capturing apparatus, on the basis of a receiving order of temporary file names. The master camera 12 associates the temporary file name with the formal file name. The master camera 12 also associates the session ID of the image capturing apparatus that has transmitted the temporary file name, as metainformation or the like, with the temporary file name and the formal file name. Therefore, the master camera 12 is capable of issuing a formal file name for an image file saved in each image capturing apparatus.

Furthermore, the master camera 12 is also capable of capturing an image in such a manner that the user presses a shutter button of the master camera 12. In this case, for example, the master camera 12 saves an image file, which is a file including a captured image, with a formal file name. Since the slave camera 11 and the master camera 12 do not operate together, the user is able to use the slave camera 11 and the master camera 12 separately.

Moreover, the slave camera 11 that operates together with the master camera 12 may capture an image in such a manner that the user presses the shutter button of the master camera 12. Note that, in a case where the master camera 12 is constituted of a PC, the slave camera 11 that operates together with the PC may capture an image in accordance with an operation performed on the PC by the user.

As described above, in the file management system, each image file can be saved with a file name that is different from a file name of another image file saved in the image capturing apparatus constituting the file management system.

In addition, the image files can be saved with the file names that are displayed in an image capturing order in the case where the image files saved in the plurality of image capturing apparatuses are imported to and displayed on one PC.

### <2. Configuration of Each Appliance>

### Hardware Configurations of Slave Camera 11 and Master Camera 12

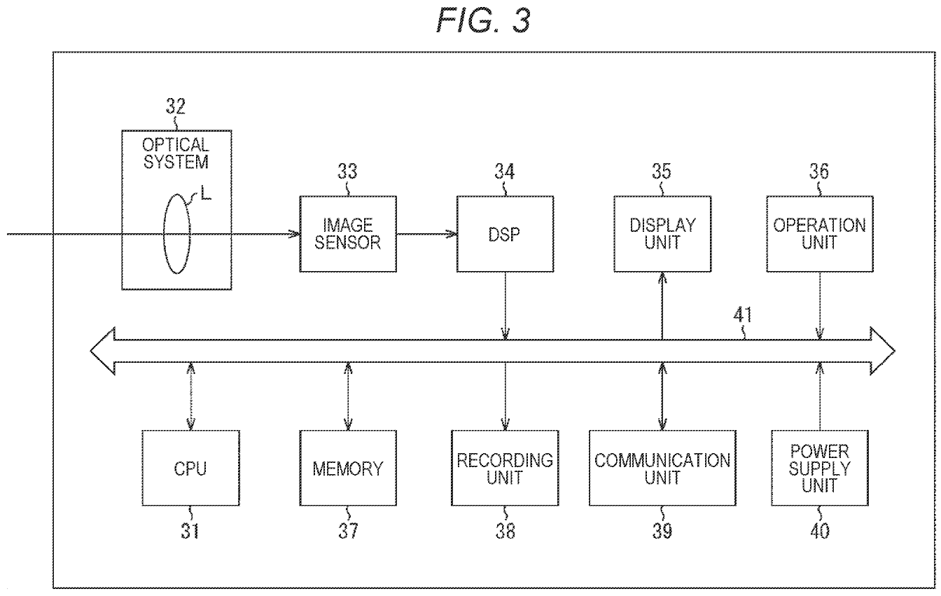

FIG. 3 is a block diagram illustrating a hardware configuration example of the image capturing apparatus. Each of the slave camera 11 and the master camera 12 is practicable using an image capturing apparatus having the configuration illustrated in FIG. 3.

As illustrated in FIG. 3, the image capturing apparatus includes a central processor unit (CPU) 31, an optical system 32, an image sensor 33, a digital signal processor (DSP) 34, a display unit 35, an operation unit 36, a memory 37, a recording unit 38, a communication unit 39, and a power supply unit 40. The CPU 31, the DSP 34, the display unit 35, the operation unit 36, the memory 37, the recording unit 38, the communication unit 39, and the power supply unit 40 are connected to one another via a bus 41.

The CPU 31 executes processing for achieving various functions of the image capturing apparatus, in accordance with programs, data, and the like stored in the memory 37.

The optical system 32 includes an imaging lens L. The imaging lens L of the optical system 32 guides image light (incident light) from a subject to the image sensor 33 and forms an image on a light receiving face of the image sensor 33.

The image sensor 33 accumulates electrons for a certain period in accordance with an image formed on the light receiving face by the imaging lens L of the optical system 32. Then, the image sensor 33 supplies, to the DSP 34, a signal in accordance with the accumulated electrons.

Upon reception of the signal from the image sensor 33, the DSP 34 subjects the signal to various kinds of signal processing to acquire an image. The image file is temporarily stored in the memory 37. The image file stored in the memory 37 is recorded in the recording unit 38 or is supplied to the display unit 35. The display unit 35 displays the image.

The operation unit 36 receives various operations by the user and supplies operation signals to the respective blocks of the image capturing apparatus.

The communication unit 39 is an interface for wireless communication. The communication unit 39 communicates with another image capturing apparatus.

The power supply unit 40 supplies power necessary for driving each block of the image capturing apparatus.

### Configuration of Slave Camera 11

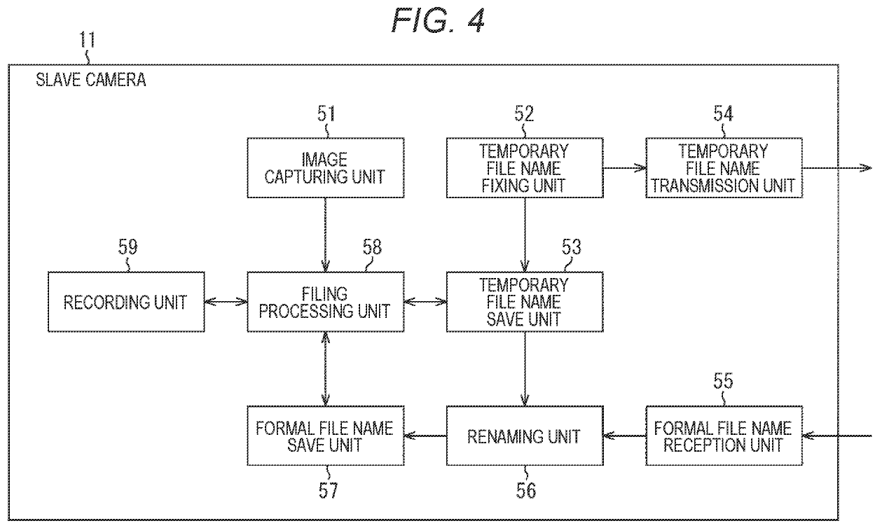

FIG. 4 is a block diagram illustrating a functional configuration example of the slave camera 11. The functional units illustrated in FIG. 4 are at least partially practicable in such a manner that the CPU 31 in FIG. 3 executes a predetermined program.

As illustrated in FIG. 4, the slave camera 11 is constituted of an image capturing unit 51, a temporary file name fixing unit 52, a temporary file name save unit 53, a temporary file name transmission unit 54, a formal file name reception unit 55, a renaming unit 56, a formal file name save unit 57, a filing processing unit 58, and a recording unit 59.

The image capturing unit 51 captures an image by driving the image sensor 33 and the like in FIG. 3, carries out predetermined signal processing, and then supplies the image (image data) to the filing processing unit 58.

The temporary file name fixing unit 52 fixes a temporary file name for the image captured by the image capturing unit 51 and supplies the temporary file name to the temporary file name save unit 53 and the temporary file name transmission unit 54.

The temporary file name save unit 53 reads an image file from the recording unit 59 via the filing processing unit 58. The temporary file name save unit 53 links the temporary file name supplied from the temporary file name fixing unit 52 with the read image file to create the image file having the temporary file name, and supplies the image file to the recording unit 59 via the filing processing unit 58. The image file is temporarily saved in the recording unit 59. The temporary file name save unit 53 also supplies the temporary file name to the renaming unit 56.

The temporary file name transmission unit 54 controls the communication unit 39 in FIG. 3 to transmit to the master camera 12 the temporary file name supplied from the temporary file name fixing unit 52. A formal file name associated with the transmitted temporary file name is transmitted from the master camera 12 that has received the temporary file name.

The formal file name reception unit 55 controls the communication unit 39 in FIG. 3, receives the formal file name transmitted from the master camera 12, and supplies the formal file name to the renaming unit 56.

The renaming unit 56 carries out renaming processing of linking the temporary file name supplied from the temporary file name save unit 53 with the formal file name supplied from the formal file name reception unit 55, thereby renaming the image file from the temporary file name to the formal file name. The formal file name subjected to the renaming processing by the renaming unit 56 is supplied to the formal file name save unit 57.

The formal file name save unit 57 reads the image file saved with the temporary file name linked with the formal file name supplied from the renaming unit 56, from the recording unit 59 via the filing processing unit 58. The formal file name save unit 57 creates the image file having the formal file name, and supplies the image file to the recording unit 59 via the filing processing unit 58. The image file is saved in the recording unit 59.

The filing processing unit 58 creates an image file using the image supplied from the image capturing unit 51, and supplies the image file to the recording unit 59. The image file is saved in the recording unit 59. Specifically, the filing processing unit 58 reads the image file saved in the recording unit 59 and supplies the image file to the temporary file name save unit 53 and the formal file name save unit 57. The filing processing unit 58 thus causes the temporary file name save unit 53 to create the image file having the temporary file name and causes the formal file name save unit 57 to create the image file having the formal file name. The created image file having the temporary file name and the created image file having the formal file name are supplied to the recording unit 59.

The recording unit 59 saves the image file having the temporary file name and the image file having the formal file name, each supplied from the filing processing unit 58. The recording unit 59 corresponds to the recording unit 38 in FIG. 3.

### Configuration of Master Camera 12

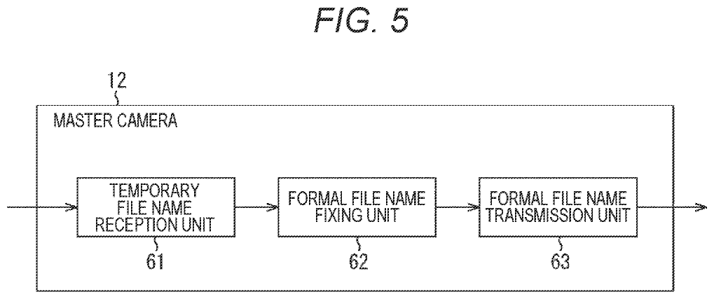

FIG. 5 is a block diagram illustrating a functional configuration example of the master camera 12. The functional units illustrated in FIG. 5 are at least partially practicable in such a manner that the CPU 31 in FIG. 3 executes a predetermined program.

As illustrated in FIG. 5, the master camera 12 is constituted of a temporary file name reception unit 61, a formal file name fixing unit 62, and a formal file name transmission unit 63.

The temporary file name reception unit 61 controls the communication unit 39 in FIG. 3, receives a temporary file name transmitted from the slave camera 11, and supplies the temporary file name to the formal file name fixing unit 62.

The formal file name fixing unit 62 fixes a formal file name for an image file saved in the slave camera 11 with the temporary file name supplied from the temporary file name reception unit 61. Here, the formal file name fixing unit 62 fixes the formal file name on the basis of a receiving order of the temporary file name. Specifically, a name including a number corresponding to the receiving order of the temporary file name is fixed as a formal file name.

The formal file name fixing unit 62 supplies the fixed formal file name to the formal file name transmission unit 63 with the fixed formal file name associated with the temporary file name.

The formal file name transmission unit 63 controls the communication unit 39 in FIG. 3, and transmits the formal file name supplied from the formal file name fixing unit 62, to the slave camera 11 that has transmitted the temporary file name.

### <3. Operation of Each Appliance>

Here, a description will be given of the operation of each appliance having the configuration described above.

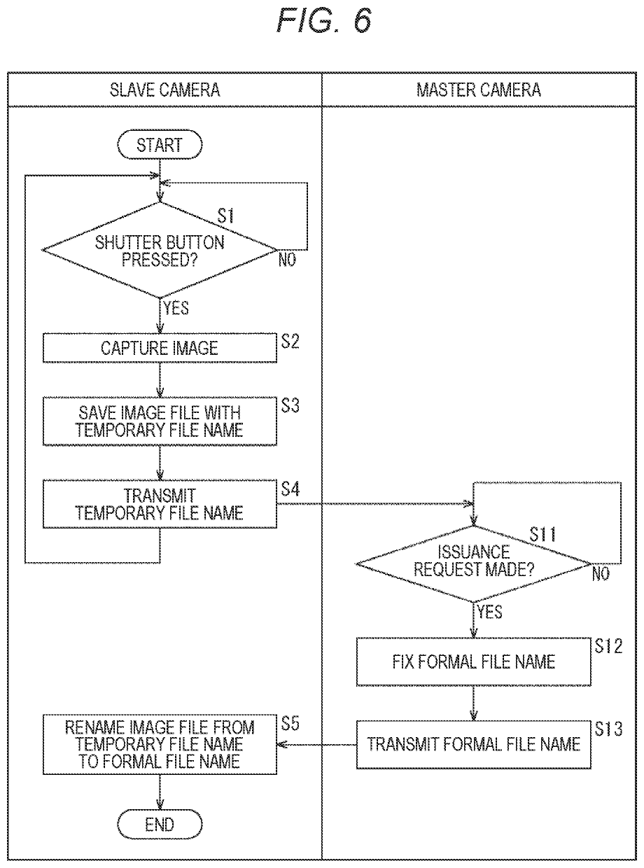

FIG. 6 is a flowchart depicting processing to be carried out by the file management system.

The processing of FIG. 6 starts, for example, when a connection between the slave camera 11 and the master camera 12 is established.

In step S1, the image capturing unit 51 of the slave camera 11 determines whether or not the shutter button has been pressed, and holds its standby state until the image capturing unit 51 determines that the shutter button has been pressed.

In a case where it is determined in step S1 that the shutter button has been pressed, the processing proceeds to step S2. In step S2, the image capturing unit 51 of the slave camera 11 captures an image, and the filing processing unit 58 of the slave camera 11 creates an image file. Then, the temporary file name fixing unit 52 of the slave camera 11 fixes a temporary file name for the image file.

In step S3, the temporary file name save unit 53 of the slave camera 11 saves the image file in the recording unit 59 with the temporary file name.

In step S4, the temporary file name transmission unit 54 of the slave camera 11 transmits the temporary file name to the master camera 12.

After transmitting the temporary file name, the slave camera 11 repeatedly carries out the foregoing processing tasks in steps S1 to S4.

On the other hand, in step S11, the temporary file name reception unit 61 of the master camera 12 determines whether or not a request is made for issuing a formal file name, and holds its standby state until the temporary file name reception unit 61 determines that the request has been made for issuing the formal file name. Here, in a case where the temporary file name reception unit 61 of the master camera 12 receives the temporary file name transmitted from the slave camera 11, the temporary file name reception unit 61 determines that the request has been made for issuing the formal file name.

In a case where it is determined in step S11 that the request has been made for issuing the formal file name, the processing proceeds to step S12. In step S12, the formal file name fixing unit 62 of the master camera 12 fixes a formal file name for the image file saved in the slave camera 11 with the temporary file name, on the basis of a receiving order of the temporary file name.

In step S13, the formal file name transmission unit 63 of the master camera 12 transmits the formal file name to the slave camera 11. The master camera 12 repeatedly carries out the foregoing processing tasks in steps S11 to S13.

In step S5, when the renaming unit 56 of the slave camera 11 receives the formal file name transmitted from the master camera 12, then the renaming unit 56 renames the image file from the temporary file name to the formal file name. Thereafter, the formal file name save unit 57 saves the image file in the recording unit 59 with the formal file name.

According to the foregoing processing, the slave camera 11 carries out the processing task (step S5) of saving the image file with the formal file name and the processing tasks (steps S1 to S4) of saving the image file with the temporary file name and transmitting the temporary file name, in parallel.

Therefore, after capturing the image, the slave camera 11 is capable of capturing a next image with a short response before issuance of a formal file name by the master camera 12. The slave camera 11 is also capable of making a request to issue a formal file name without missing an opportunity to capture an image even in a case of continuously capturing images, a case of capturing a moving image, and other cases.

Note that it is assumed that the slave camera 11 transmits the temporary file name to the master camera 12 at the image capturing timing. Here, the image capturing timing can be any timing between a point in time when an image file is generated and a point in time when a next image file is generated.

The foregoing description concerns a case where the image capturing timing is a timing between the point in time when the image file is saved with the temporary file name and the point in time when the next image file is generated. Alternatively, for example, the image capturing timing may be a timing between the point in time when the image file is generated and the point in time when the image file is saved with the temporary file name.

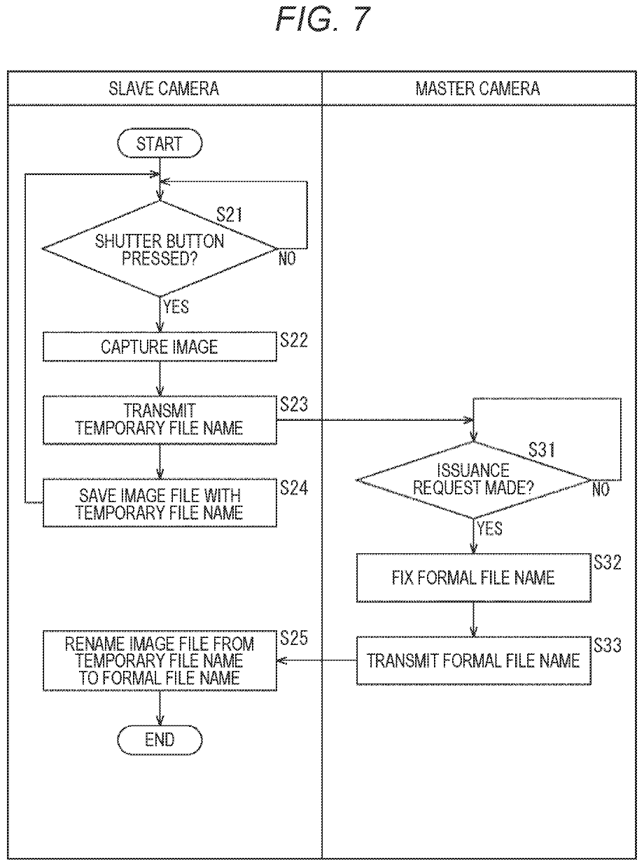

With reference to a flowchart of FIG. 7, a description will be given of another processing to be carried out by the file management system. This processing is different in timing of transmitting a temporary file name from the foregoing processing.

Processing tasks in steps S21 and S22 are similar to the processing tasks in steps S1 and S2 illustrated in FIG. 6. That is, in a case where the shutter button is pressed, an image is captured and an image file is generated. Furthermore, a temporary file name is fixed for the image file.

In step S23, the temporary file name transmission unit 54 of the slave camera 11 transmits the temporary file name to the master camera 12.

In step S24, the temporary file name save unit 53 of the slave camera 11 saves the image file in the recording unit 59 with the temporary file name.

After saving the image file with the temporary file name, the slave camera 11 repeatedly carries out the foregoing processing tasks in steps S21 to S24.

Processing tasks in steps S31 to S33 to be carried out by the master camera 12 are similar to the processing tasks in steps S11 to S13 illustrated in FIG. 6. Furthermore, a processing task in step S25 to be carried out by the slave camera 11 is similar to the processing task in step S5 illustrated in FIG. 6.

As described above, the timing at which the temporary file name is transmitted can be set at any timing between a point time when an image file is generated and a point in time when a next image file is generated.

For example, the image capturing timing may be a timing at which an image file is generated. Alternatively, the image capturing timing may be a timing at which an image file is saved with a temporary file name.

### <4. Case Where Image File is Saved in Master Camera>

An image file generated by the slave camera 11 may be saved in the master camera 12 with a formal file name.

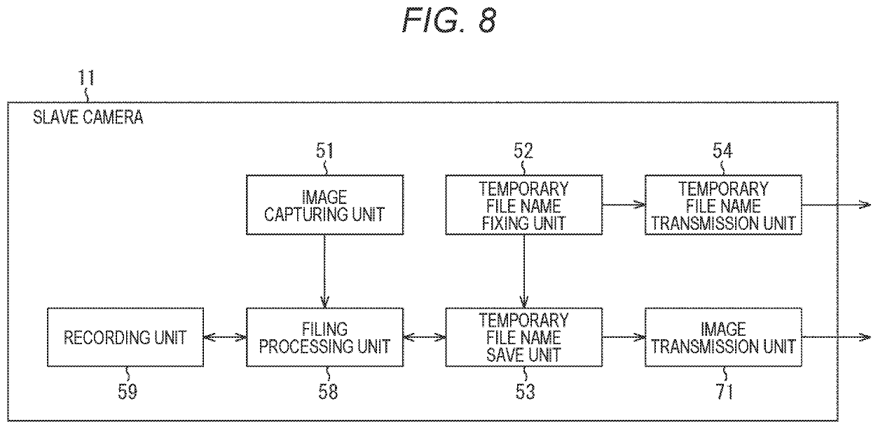

FIG. 8 is a block diagram illustrating a functional configuration example of a slave camera 11 that transmits an image file.

In FIG. 8, the same configurations as the configurations of the slave camera 11 in FIG. 4 are denoted by the same reference signs. The duplicate description will be omitted as appropriate.

The slave camera 11 illustrated in FIG. 8 includes an image transmission unit 71 in addition to an image capturing unit 51, a temporary file name fixing unit 52, a temporary file name save unit 53, a temporary file name transmission unit 54, a filing processing unit 58, and a recording unit 59 that have been described with reference to FIG. 4.

The image transmission unit 71 acquires an image having a temporary file name from the temporary file name save unit 53. The image transmission unit 71 controls the communication unit 39 in FIG. 3 and transmits the image file to the master camera 12.

Note that the image transmission unit 71 does not transmit the image file having the temporary file name to the master camera 12, but may transmit a thumbnail or a proxy file representing the image file to the master camera 12.

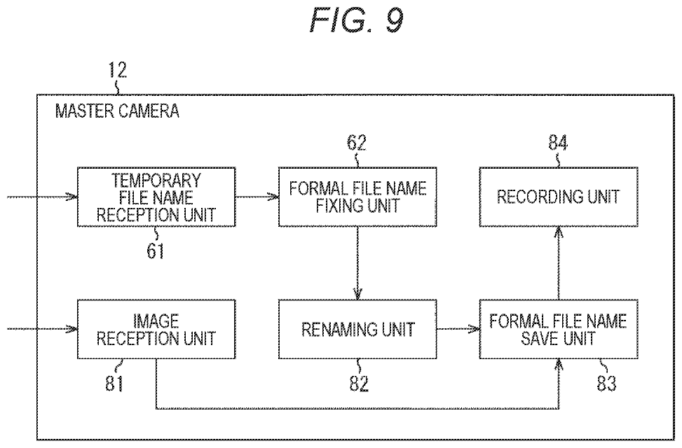

FIG. 9 is a block diagram illustrating a functional configuration example of a master camera 12 that receives an image file.

In FIG. 9, the same configurations as the configurations of the master camera 12 in FIG. 5 are denoted by the same reference signs. The duplicate description will be omitted as appropriate.

The master camera 12 illustrated in FIG. 9 includes an image reception unit 81, a renaming unit 82, a formal file name save unit 83, and a recording unit 84 in addition to a temporary file name reception unit 61 and a formal file name fixing unit 62 that have been described with reference to FIG. 5.

The image reception unit 81 controls the communication unit 39 in FIG. 3, receives an image file transmitted from the slave camera 11, and supplies the image file to the formal file name save unit 83.

The renaming unit 82 receives a formal file name associated with a temporary file name from the formal file name fixing unit 62.

The renaming unit 82 carries out renaming processing and supplies the formal file name to the formal file name save unit 83.

The formal file name save unit 57 creates the image file having the formal file name, using the image file supplied from the image reception unit 81 and the formal file name supplied from the renaming unit 82. The image file having the formal file name, which has been created by the formal file name save unit 57, is saved in the recording unit 84. The recording unit 84 corresponds to the recording unit 38 in FIG. 3.

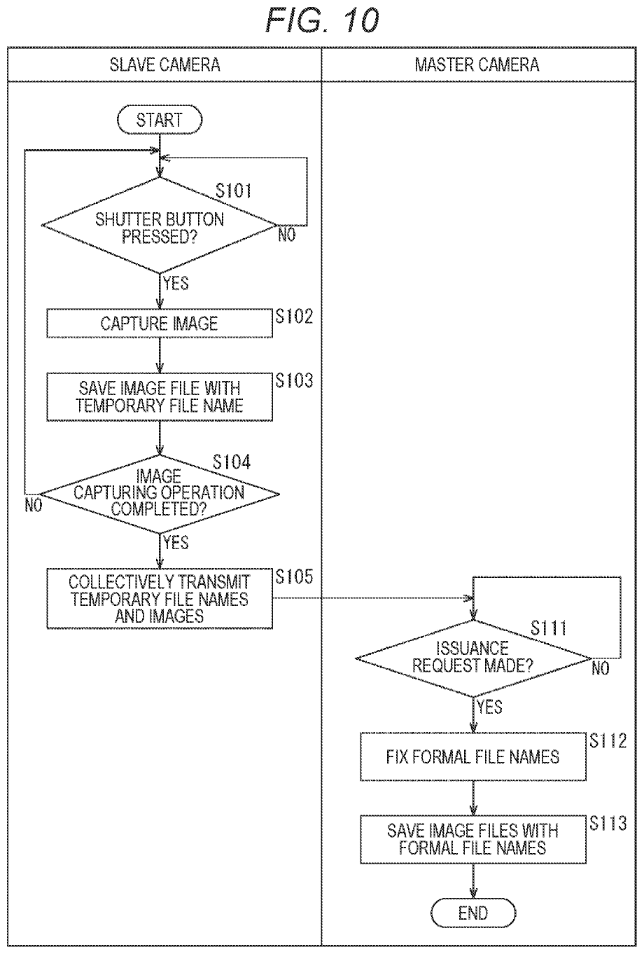

With reference to a flowchart of FIG. 10, here, a description will be given of processing to be carried out by the file management system having the configuration described above.

Processing tasks in steps S101 to S103 are similar to the processing tasks in steps S1 to S3 illustrated in FIG. 6. That is, in a case where the shutter button is pressed, an image file is generated and is saved with a temporary file name.

In step S104, the image capturing unit 51 of the slave camera 11 determines whether or not the image capturing operation has been completed.

In a case where it is determined in step S104 that the image capturing operation has not been completed yet, the processing returns to step S101. Thereafter, the processing tasks in and subsequent to step S101 are carried out.

In a case where it is determined in step S104 that the image capturing operation has been completed, the processing proceeds to step S105. For example, in a case where the shutter button has not been pressed for a predetermined period, it is determined that the image capturing operation has been completed. It may be determined that the image capturing operation has been completed in a case where a preset number of images has been captured. Alternatively, a user may select the completion of the image capturing operation.

In step S105, the temporary file name transmission unit 54 of the slave camera 11 collectively transmits, to the master camera 12, the temporary file names of the image files generated until the completion of the image capturing operation. Simultaneously with the transmission of the temporary file names, the image transmission unit 71 collectively transmits, to the master camera 12, the image files generated until the completion of the image capturing operation.

After transmitting the image files, the slave camera 11 repeatedly carries out the foregoing processing tasks in steps S101 to S105.

Note that the temporary file name transmission unit 54 may transmit the temporary file names to the master camera 12 in conjunction with time-of-day information indicating a date and time when an image included in an image file saved with a temporary file name was captured. In this case, the master camera 12 fixes a formal file name, on the basis of an order of image capturing date and time.

On the other hand, processing tasks in steps S111 and S112 to be carried out by the master camera 12 are similar to the processing tasks in steps S11 and S12 illustrated in FIG. 6. That is, in a case where a temporary file name is received, a formal file name is fixed for an image file saved in the slave camera 11 with the temporary file name.

The master camera 12 that has received the temporary file name also receives the image file.

In step S113, the renaming unit 82 of the master camera 12 renames the image file from the temporary file name to the formal file name. Thereafter, the formal file name save unit 83 saves the image file in the recording unit 84 with the formal file name.

After saving the image file with the formal file name, the master camera 12 repeatedly carries out the foregoing processing tasks in steps S111 to S113.

As described above, the master camera 12 is capable of saving the respective image files with the file names different from the file names of the image files saved in the master camera 12.

Furthermore, in a case where the formal file name is fixed on the basis of the image capturing date and time, when the image file saved in the master camera 12 is imported to and displayed on the PC, the image file can be saved with the file name displayed in the image capturing order.

The foregoing description concerns a case where a temporary file name is transmitted at a timing between a point in time when an image capturing operation is completed and a point in time when a next image is generated. Alternatively, for example, a temporary file name may be transmitted at a timing between a point in time when an image file is saved with a temporary file name and a point in time when it is determined whether or not an image capturing operation has been completed.

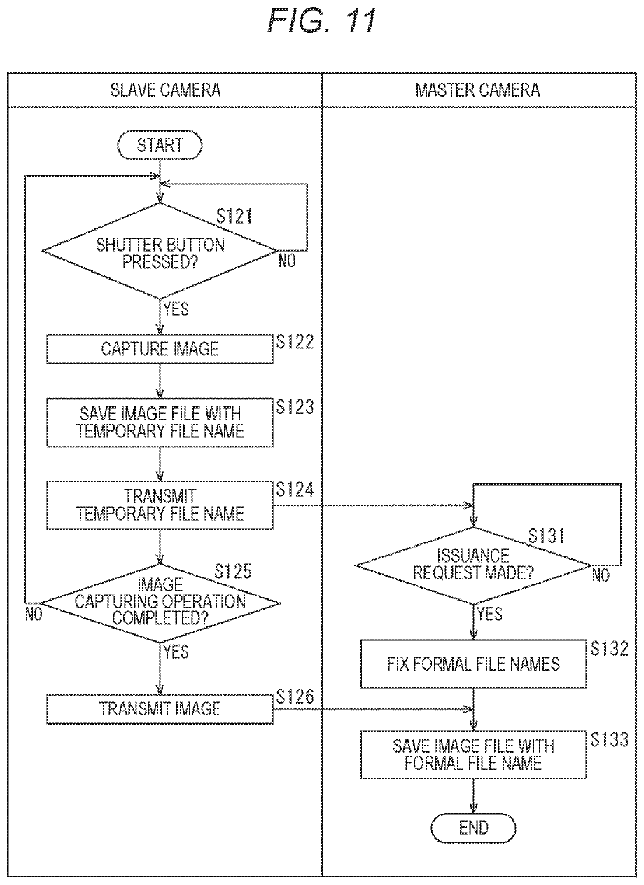

With reference to a flowchart of FIG. 11, a description will be given of another processing to be carried out by the file management system. This processing is different in timing of transmitting a temporary file name from the foregoing processing.

Processing tasks in steps S121 to S123 are similar to the processing tasks in steps S101 to S103 illustrated in FIG. 10. That is, in a case where the shutter button is pressed, an image file is generated and is saved with a temporary file name.

In step S124, the temporary file name transmission unit 54 of the slave camera 11 transmits the temporary file name to the master camera 12.

Processing tasks in steps S131 and S132 to be carried out by the master camera 12 are similar to the processing tasks in steps S1111 and S112 illustrated in FIG. 10. That is, in a case where a temporary file name is received, a formal file name is fixed for an image file saved in the slave camera 11 with the temporary file name.

After fixing the formal file name, the master camera 12 holds its standby state in a state in which the master camera 12 is capable of receiving a temporary file name and an image file, until an image file is transmitted from the slave camera 11.

On the other hand, a processing task in step S125 to be carried out by the slave camera 11 after transmitting the temporary file name is similar to the processing task in step S104 illustrated in FIG. 10.

In step S126, the image transmission unit 71 of the slave camera 11 transmits, to the master camera 12, the image files generated until the completion of the image capturing operation.

After transmitting the image files, the slave camera 11 repeatedly carries out the foregoing processing tasks in steps S121 to S126.

In step S133, when the renaming unit 82 of the master camera 12 receives the image file, then the renaming unit 82 renames the image file from the temporary file name to the formal file name. Thereafter, the formal file name save unit 83 saves the image file in the recording unit 84 with the formal file name.

After saying the image file with the formal file name, the master camera 12 repeatedly carries out the foregoing processing tasks in steps S131 to S133.

As described above, the temporary file names may be collectively transmitted after completion of a series of image capturing operations, or may be transmitted at a timing after the image file is saved with the temporary file name.

<5. Case Where Image is Captured in State in which Connection is not Established>
Example in which Temporary File Names are Collectively Transmitted

In a case where the slave camera 11 saves an image file with a temporary file name in a state in which the slave camera 11 is not connected to the master camera 12, the slave camera 11 is capable of transmitting the temporary file name to the master camera 12 when the slave camera 11 is connected to the master camera 12.

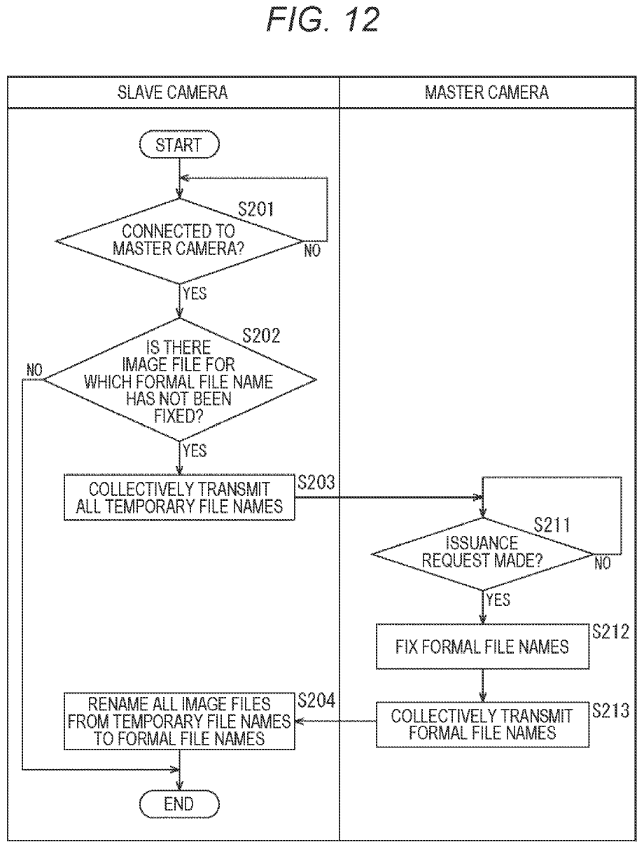

With reference to a flowchart of FIG. 12, a description will be given of processing to be carried out by the file management system.

The processing in FIG. 12 starts, for example, after the slave camera 11 captures an image and saves an image file with a temporary file name in a state in which a connection to the master camera 12 is not established.

In step S201, the temporary file name transmission unit 54 of the slave camera 11 (FIG. 4) determines whether or not the slave camera 11 has been connected to the master camera 12, and holds its standby state until the temporary file name transmission unit 54 determines that the slave camera 11 has been connected to the master camera 12.

In a case where it is determined in step S201 that the slave camera 11 has been connected to the master camera 12, the processing proceeds to step S202. In step S202, the temporary file name transmission unit 54 determines whether or not there is an image file for which a formal file name has not been fixed.

In a case where it is determined in step S202 that there is no image file for which a formal file name has not been fixed, the processing ends. For example, the temporary file name transmission unit 54 is capable of temporarily storing a temporary file name that can not be transmitted because the slave camera 11 has not been connected to the master camera 12. In a case where there is a temporary file name stored in the temporary file name transmission unit 54, it is determined that there is an image file for which a formal file name has not been fixed.

In a case where it is determined in step S202 that there is an image file for which a formal file name has not been fixed, the processing proceeds to step S203. In step S203, the temporary file name transmission unit 54 of the slave camera 11 collectively transmits, to the master camera 12, all the temporary file names that could not be transmitted.

On the other hand, processing tasks in steps S211 and S212 to be carried out by the master camera 12 are similar to the processing tasks in steps S11 and S12 illustrated in FIG. 6. That is, in a case where a temporary file name is received, a formal file name is fixed for an image file saved in the slave camera 11 with the temporary file name.

In step S213, the formal file name transmission unit 63 of the master camera 12 collectively transmits the formal file names to the slave camera 11.

In step S204, when the renaming unit 56 of the slave camera 11 receives the formal file names, then the renaming unit 56 renames all the image files for which the formal file names have not been fixed, from the temporary file names to the formal file names. The formal file name save unit 57 saves the image files in the recording unit 59 with the formal file names.

According to the foregoing processing, the slave camera 11 is capable of saving image files saved in a state in which the slave camera 11 is not connected to the master camera 12, with file names different from file names of image files saved in the image capturing apparatus constituting the file management system.

Note that the temporary file name transmission unit 54 of the slave camera 11 may transmit the temporary file name to the master camera 12 in conjunction with time-of-day information. Therefore, even in a case where a plurality of image capturing apparatuses is used as the slave cameras 11, the master camera 12 is capable of issuing formal file names to image files of images captured by the plurality of image capturing apparatuses, on the basis of the time-of-day information. In the file management system, as a result, the image files can be saved with the file names that are displayed in an image capturing order in the case where the image files saved in the plurality of image capturing apparatuses are imported to and displayed on one PC.

Furthermore, the slave camera 11 is capable of carrying out the foregoing processing in parallel with the processing of capturing an image and saving an image file with a temporary file name, which has been described with reference to FIG. 6 and the like. That is, the slave camera 11 is capable of capturing an image and saving an image file with a temporary file name even in the state in which the slave camera 11 is not connected to the master camera 12.

Example in which User Receives Notification that There is Image File for which Formal File Name has not Been Fixed

In a case where an image file is saved with a temporary file name in a state in which the slave camera 11 is not connected to the master camera 12, the user may receive a notification that there is an image file for which a formal file name has not been fixed.

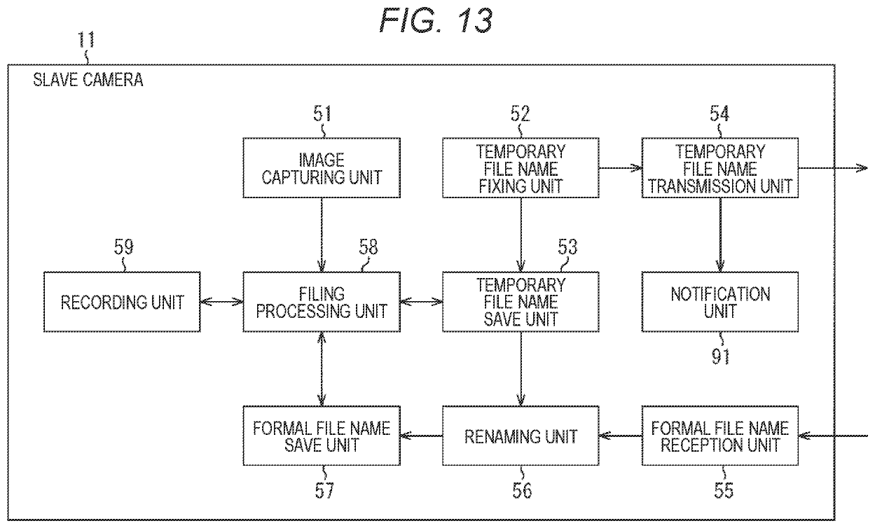

FIG. 13 is a block diagram illustrating a functional configuration example of a slave camera 11 that includes a notification unit.

In FIG. 13, the same configurations as the configurations of the slave camera 11 in FIG. 4 are denoted by the same reference signs. The duplicate description will be omitted as appropriate.

The slave camera 11 illustrated in FIG. 13 includes a notification unit 91 in addition to an image capturing unit 51, a temporary file name fixing unit 52, a temporary file name save unit 53, a temporary file name transmission unit 54, a formal file name reception unit 55, a renaming unit 56, a formal file name save unit 57, a filing processing unit 58, and a recording unit 59 that have been described with reference to FIG. 4.

In a case where the slave camera 11 is connected to the master camera 12, when there is a stored temporary file name, the temporary file name transmission unit 54 supplies, to the notification unit 91, information indicating that there is an image file for which a formal file name has not been fixed.

The notification unit 91 controls the display unit 35 in FIG. 3, and notifies the user that there is an image file for which a formal file name has not been fixed, in such a manner that this notification is displayed on the display unit 35, on the basis of the information supplied from the temporary file name transmission unit 54.

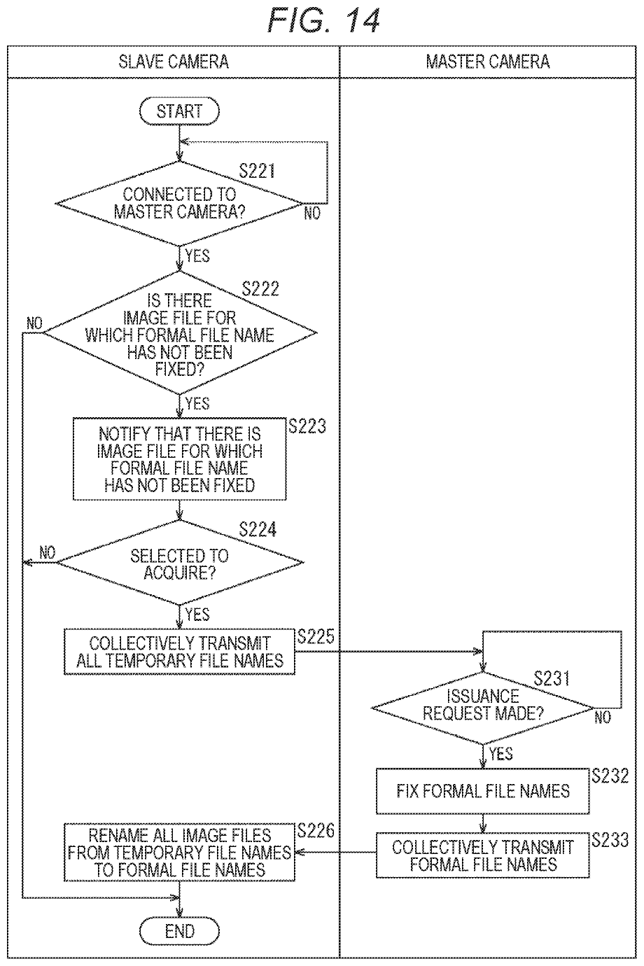

With reference to a flowchart of FIG. 14, a description will be of processing to be carried out by the file management system having the configuration described above.

Processing tasks in steps S221 and S222 are similar to the processing tasks in steps S201 and S202 illustrated in FIG. 12. That is, in a case where the slave camera 11 is connected to the master camera 12, when there as an image file for which a formal file name has not been fixed, the processing proceeds to step S223.

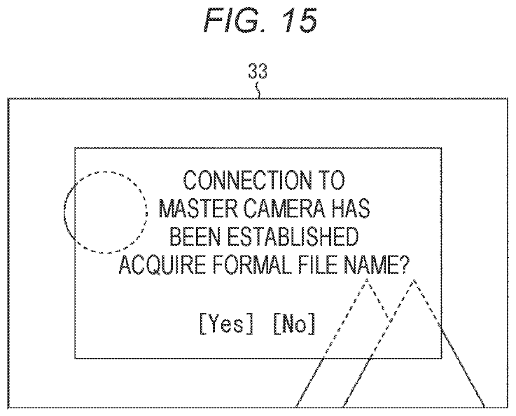

In step S223, the notification unit 91 of the slave camera 11 makes a notification that there is an image file for which a formal file name has not been fixed. Here, the notification unit 91 causes the display unit 35 to display, for example, a screen illustrated in FIG. 15.

As illustrated in FIG. 15, on the display unit 35 of the slave camera 11, a text is displayed in a rectangular frame while being superimposed on an image file stored in the memory 37. As illustrated in FIG. 15, the display unit 35 displays a massage notifying that the slave camera 11 is connected to the master camera 12 and asking whether or not to acquire a formal file name and an option ([Yes]/[No]) for selecting whether or not to acquire the formal file name.

The slave camera 11 displays such a text, thereby notifying the user that there is an image file for which a formal file name has not been fixed.

The user selects whether or not to acquire the formal file name of the image file for which the formal file name has not been fixed by, for example, operating the operation unit 36 of the slave camera 11.

Returning to the description referring to FIG. 14, in step S224, the temporary file name transmission unit 54 determines whether or not the user has selected to acquire the formal file name of the image file for which the formal file name has not been fixed.

In a case where it is determined in step S224 that the user has selected not to acquire the formal file name of the image file for which the formal file name has not been fixed, the processing ends. Here, for example, in a case where [No] is selected on the display described with reference to FIG. 15, it is determined that the user has selected not to acquire the formal file name of the image file for which the formal file name has not been fixed.

On the other hand, in a case where it is determined in step S224 that the user has selected to acquire the formal file name of the image file for which the formal file name has not been fixed, the processing proceeds to step S225. Here, for example, in a case where [Yes] is selected on the display described with reference to FIG. 15, it is determined that the user has selected to acquire the formal file name of the image file for which the formal file name has not been fixed.

In step S225, the temporary file name transmission unit 54 of the slave camera 11 collectively transmits, to the master camera 12, all the temporary file names that could not be transmitted.

Processing tasks in steps S231 to S233 to be carried out by the master camera 12 are similar to the processing tasks in steps S211 to S213 illustrated in FIG. 12. Furthermore, a processing task in step S226 to be carried out by the slave camera 11 is similar to the processing task in step S204 illustrated in FIG. 12.

As described above, the user is able to select whether or not to save the image file saved, with the formal file name, in the slave camera 11 that is in the state not connected to the master camera 12.

Note that, also in this example, the temporary file name transmission unit 54 of the slave camera 11 may transmit the temporary file name to the master camera 12 in conjunction with time-of-day information. Therefore, even in a case where a plurality of image capturing apparatuses is used as the slave cameras 11, the master camera 12 is capable of issuing formal file names to image files saved in the plurality of image capturing apparatuses, on the basis of the time-of-day information. In the file management system, as a result, the image files can be saved with the file names that are displayed in an image capturing order in the case where the image files saved in the plurality of image capturing apparatuses are imported to and displayed on one PC.

### <6. Modifications>

In a case where a series of image capturing operations for generating a plurality of image files, such as a continuous image capturing operation or a bracket image capturing operation, is performed by the slave camera 11, the slave camera 11 transmits temporary file names to the master camera 12 at a timing of generating image files.

In this case, the image files can be saved with formal file names fixed on the basis of the timing at which the image files are generated (a timing at which the temporary file names are received), irrespective of the number of image files to be generated by the series of image capturing operations.

When image files saved in a plurality of image capturing apparatuses are imported to one PC, file names excluding extensions of all image files may be renamed from temporary file names to formal file names in accordance with a list of formal file names held by the master camera 12.

Data to be exchanged between the slave camera 11 and the master camera 12 may be transmitted to all the appliances connected to the network by configuring the file management system in a broadcast manner.

### <7. Configuration Example of Computer>

The foregoing processing carried out by the master camera 12 can be executed by hardware and can also be executed by software. In a case where the series of processing tasks is executed by software, a program constituting the software is loaded from a program recording medium and installed in a computer incorporated in special-purpose hardware, a general-purpose personal computer, or the like.

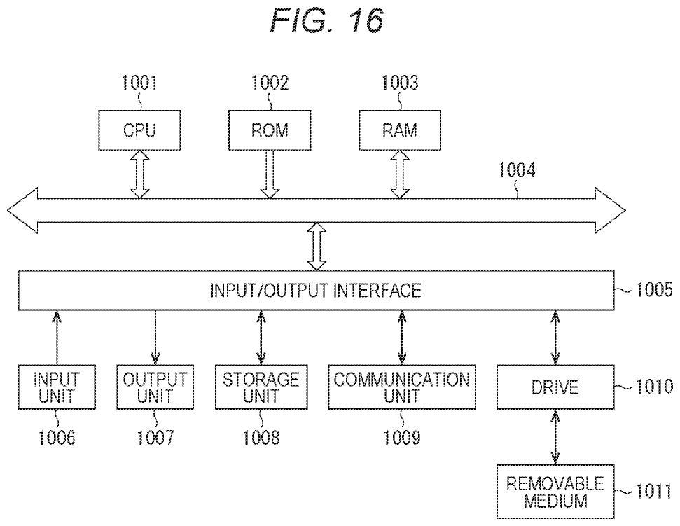

FIG. 16 is a block diagram illustrating a hardware configuration example of a computer that installs therein the program to carry out the foregoing series of processing tasks.

A central processing unit (CPU) 1001, a read only memory (ROM) 1002, and a random access memory (RAM) 1003 are connected to one another via a bus 1004.

Moreover, an input/output interface 1005 is connected to the bus 1004. An input unit 1006 including a keyboard, a mouse, and the like and an output unit 1007 including a display, a speaker, and the like are connected to the input/output interface 1005. Furthermore, a storage unit 1008 including a hard disk, a nonvolatile memory, and the like, a communication unit 1009 including a network interface and the like, and a drive 1010 that drives a removable medium 1011 are connected to the input/output interface 1005.

In the computer configured as described above, the CPU 1001 loads, for example, a program stored in the storage unit 1008, onto the RAM 1003 via the input/output interface 1005 and the bus 1004 to execute the program, thereby carrying out the foregoing series of processing tasks.

The program to be executed by the CPU 1001 is provided, for example, by the removable medium 1011 in which the program is recorded or via a wired or wireless transmission medium such as a local area network, the Internet, or digital broadcasting, and is installed in the storage unit 1008.

Note that the program to be executed by the computer may be a program by which processing tasks are carried out on a time-series basis in accordance with the sequence described in the present specification, or may be a program by which processing tasks are carried out in parallel or are carried out at a required timing such as a time when the program is called up.

Note that the term “system” in the present specification refers to an aggregate of a plurality, of constituent elements (apparatuses, modules (components), and the like), and it does not matter whether or not all the constituent elements are an the same housing. Therefore, the term “system” involves both of a plurality of apparatuses accommodated in separate housings and connected to one another via a network and a single apparatus in which a plurality of modules is accommodated in a single housing.

Note that the effects described in the present specification are merely exemplary and not limitative, and there may be achieved other effects.

Embodiments of the present technology are not limited to the foregoing embodiments, and various variations can be made without departing from the gist of the present technology.

For example, the present technology can take a configuration of cloud computing in which a plurality of apparatuses processes one function via a network in collaboration with one another on a task-sharing basis.

Furthermore, the respective steps described with reference to the foregoing flowcharts can be executed by a single apparatus or can be executed by a plurality of apparatuses with the steps divided among the plurality of apparatuses.

Moreover, in a case where a single step includes a plurality of processing tasks, the plurality of processing tasks included in the single step can be carried out by a single apparatus or can be carried out by a plurality of apparatuses with the plurality of processing tasks divided among the plurality of apparatuses.

### <Combination Example of Configurations>

The present technology can adopt the following configurations.
(1)

A file management system including:

an image capturing apparatus; and

an information processing apparatus connectable to the image capturing apparatus,

in which

the image capturing apparatus includes:

a temporary file name save unit configured to save an image file including a captured image, with a temporary file name irrespective of whether or not the image capturing apparatus is connected to the information processing apparatus; and

a temporary file name transmission unit configured to transmit the temporary file name to the information processing apparatus at an image capturing timing, and

the information processing apparatus includes

a formal file name fixing unit configured to fix a formal file name for the image file when the temporary file name is received.
(2)

The file management system as recited in (1), in which

the information processing apparatus further includes a formal file name transmission unit configured to transmit the fixed formal file name to the image capturing apparatus, and

the image capturing apparatus further includes a formal file name save unit configured to save the image file with the formal file name when the formal file name is received.
(3)

The file management system as recited in (1) or (2), in which

the image capturing apparatus further includes an image transmission unit configured to transmit the image file to the information processing apparatus, and

the information processing apparatus further includes a formal file name save unit configured to save the image file with the formal file name when the image file is received.
(4)

The file management system as recited in any of (1) to (3), in which

the formal file name fixing unit fixes the formal file name for the image file on the basis of a receiving order of the temporary file name.
(5)

The file management system as recited in (4), in which

the formal file name fixing unit fixes the formal file name for the image file saved in each of a plurality of the image capturing apparatuses, on the basis of a receiving order of a plurality of the temporary file names from the image capturing apparatuses.
(6)

The file management system as recited in (4) or (5), in which

the formal file name fixing unit fixes the formal file name including a number associated with the receiving order of the temporary file name.
(7)

The file management system as recited in any of (1) to (6), in which

in a case where the image capturing apparatus is connected to the information processing apparatus, the temporary file name transmission unit transmits the temporary file name of the image file for which the formal file name has not been fixed, to the information processing apparatus.
(8)

The file management system as recited in (7), in which

the image capturing apparatus further includes a notification unit configured to notify a user that there is the image file for which the formal file name has not been fixed, and

the temporary file name transmission unit transmits the temporary file name to the information processing apparatus in accordance with an operation by the user.
(9)

The file management system as recited in (7) or (8), in which

in a case where the image capturing apparatus is connected to the information processing apparatus, the temporary file name transmission unit transmits the temporary file name of the image file for which the formal file name has not been fixed, to the information processing apparatus in conjunction with time-of-day information indicating a time of day when the image included in the image file is captured.
(10)

The file management system as recited in any of (1) to (9), in which

the image capturing timing is a timing at which the image file is generated.
(11)

The file management system as recited in any of (1) to (9), in which

the image capturing timing is a timing between a point in time when the image file is generated and a point in time when the image file is saved with the temporary file name.
(12)

The file management system as recited in any of (1) to (9), in which

the image capturing timing is a timing at which the image file is saved with the temporary file name.
(13)

The file management system as recited in any of (1) to (9), in which

the image capturing timing is a timing between a point in time when the image file is saved with the temporary file name and a point in time when a next image file is generated.
(14)

An information processing apparatus including:

a temporary file name reception unit configured to receive a temporary file name transmitted from an image capturing apparatus; and

a formal file name fixing unit configured to fix a formal file name for an image file saved in the image capturing apparatus with the temporary file name, when the temporary file name is received.
(15)

An image capturing apparatus including:

a temporary file name save unit configured to save an image file including a captured image, with a temporary file name irrespective of whether or not the image capturing apparatus is connected to an information processing apparatus; and

a temporary file name transmission unit configured to transmit the temporary file name to the information processing apparatus that fixes a formal file name for the image file, at an image capturing timing.
(16)

A file management method including:

causing an image capturing apparatus to save an image file including a captured image, with a temporary file name irrespective of whether or not the image capturing apparatus is connected to an information processing apparatus;

causing the image capturing apparatus to transmit the temporary file name to the information processing apparatus at an image capturing timing; and

causing the information processing apparatus to fix a formal file name for the image file when the temporary file name is received.

### REFERENCE SIGNS LIST

11-1, 11-2, 11-3, 11 Slave camera
12 Master camera
51 Image capturing unit
52 Temporary file name fixing unit
53 Temporary file name save unit
54 Temporary file name transmission unit
55 Formal file name fixing unit
56 Renaming unit
57 Formal file name save unit
58 Filing processing unit
59 Recording unit
61 Temporary file name reception unit
62 Formal file name fixing unit
63 Formal file name transmission unit
71 Image transmission unit
81 Image reception unit
82 Renaming unit
83 Formal file name save unit
84 Recording unit
91 Notification unit

1. A file management system comprising:
an image capturing apparatus; and
an information processing apparatus connectable to the image capturing apparatus,
wherein
the image capturing apparatus includes:
a temporary file name save unit configured to save an image file including a captured image, with a temporary file name irrespective of whether or not the image capturing apparatus is connected to the information processing apparatus; and
a temporary file name transmission unit configured to transmit the temporary file name to the information processing apparatus at an image capturing timing, and
the information processing apparatus includes
a formal file name fixing unit configured to fix a formal file name for the image file when the temporary file name is received.

2. The file management system according to claim 1, wherein
the information processing apparatus further includes a formal file name transmission unit configured to transmit the fixed formal file name to the image capturing apparatus, and
the image capturing apparatus further includes a formal file name save unit configured to save the image file with the formal file name when the formal file name is received.

3. The file management system according to claim 1, wherein
the image capturing apparatus further includes an image transmission unit configured to transmit the image file to the information processing apparatus, and
the information processing apparatus further includes a formal file name save unit configured to save the image file with the formal file name when the image file is received.

4. The file management system according to claim 1, wherein
the formal file name fixing unit fixes the formal file name for the image file on a basis of a receiving order of the temporary file name.

5. The file management system according to claim 4, wherein
the formal file name fixing unit fixes the formal file name for the image file saved in each of a plurality of the image capturing apparatuses, on a basis of a receiving order of a plurality of the temporary file names from the image capturing apparatuses.

6. The file management system according to claim 4, wherein
the formal file name fixing unit fixes the formal file name including a number associated with the receiving order of the temporary file name.

7. The file management system according to claim 1, wherein
in a case where the image capturing apparatus is connected to the information processing apparatus, the temporary file name transmission unit transmits the temporary file name of the image file for which the formal file name has not been fixed, to the information processing apparatus.

8. The file management system according to claim 7, wherein
the image capturing apparatus further includes a notification unit configured to notify a user that there is the image file for which the formal file name has not been fixed, and
the temporary file name transmission unit transmits the temporary file name to the information processing apparatus in accordance with. an operation by the user.

9. The file management system according to claim 7, wherein
in a case where the image capturing apparatus is connected to the information processing apparatus, the temporary file name transmission unit transmits the temporary file name of the image file for which the formal file name has not been fixed, to the information processing apparatus in conjunction with time-of-day information indicating a time of day when the image included in the image file is captured.

10. The file management system according to claim 1, wherein
the image capturing timing comprises a timing at which the image file is generated.

11. The file management system according to claim 1, wherein
the image capturing timing comprises a timing between a point in time when the image file is generated and a point in time when the image file is saved with the temporary file name.

12. The file management system according to claim 1, wherein
the image capturing timing comprises a timing at which the image file is saved with the temporary file name.

13. The file management system according to claim 1, wherein
the image capturing timing comprises a timing between a point in time when the image file is saved with the temporary file name and a point in time when a next image file is generated.

14. An information processing apparatus comprising:
a temporary file name reception unit configured to receive a temporary file name transmitted from an image capturing apparatus; and
a formal file name fixing unit configured to fix a formal file name for an image file saved in the image capturing apparatus with the temporary file name, when the temporary file name is received.

15. An image capturing apparatus comprising:
a temporary file name save unit configured to save an image file including a captured image, with a temporary file name irrespective of whether or not the image capturing apparatus is connected to an information processing apparatus; and
a temporary file name transmission unit configured to transmit the temporary file name to the information processing apparatus that fixes a formal file name for the image file, at an image capturing timing.

16. A file management method comprising:
causing an image capturing apparatus to save an image file including a captured image, with a temporary file name respective of whether or not the image capturing apparatus is connected to an information processing apparatus;
causing the image capturing apparatus to transmit the temporary file name to the information processing apparatus at an image capturing timing; and
causing the information processing apparatus to fix a formal file name for the image file when the temporary file name is received.
